(19) United States
(12) Patent Application Publication
(10) Pub. No.: US 2018/0281164 A1
(43) Pub. Date: Oct. 4, 2018

(54) EXTRACTOR AND EXTRACTION PROCESS OF AN INJECTOR STUCK IN THE ENGINE CYLINDER HEAD OF A MOTOR VEHICLE

(71) Applicant: HUBITOOLS SA, Wavre (BE)

(72) Inventor: Yannick Dudot, Cappel (FR)

(21) Appl. No.: 15/940,287

(22) Filed: Mar. 29, 2018

(30) Foreign Application Priority Data
Mar. 31, 2017 (BE) 2017/5230
Mar. 31, 2017 (FR) 1770327

(51) Int. Cl. B25D 1/16; B25B 27/00

(52) U.S. Cl. CPC B25D 1/16; F02M 61/14; B25B 27/0035

(57) ABSTRACT

Extraction process of an injector (1) stuck in its housing (3) within a cylinder head (5) of a motor vehicle, the said injector (1) comprising a body (9), a part of which protrudes from the outside of the housing (3), the protruding part having a high-pressure connection (13), the process comprising the mounting of an extractor (15) to the high-pressure connection (13) of the injector (1); and the extraction of the injector (1) by using the extractor (15). The process is remarkable in that step b) dealing with the extraction of the injector (1) includes the retrieval of the injector (1) so as to trigger the rotation of the injector (1) around the longitudinal axis of the injector 1.

### FIELD OF THE INVENTION

The invention belongs to the process and tooling area for the automobile mechanics and specifically involves the processes and tools for the extraction of an engine injector belonging to a motor vehicle, for example a motor vehicle.

### BACKGROUND

In a combustion engine of a motor vehicle, the fuel is under pressure before being injected in an engine combustion chamber using an injector. This injector is housed in a cylinder head and has a body with a part that protrudes from the cylinder head surface. This protruding part traditionally includes an electric control linked to the electronic system of the vehicle and a high-pressure connection through which the fuel under pressure is supplied. Traditionally, the protruding part of the injector extends to the outside surface of the cylinder head in the extension of the rest of the body and the electric control is located at the end of this protruding part. As for the high-pressure connection, it extends angularly in relation to this protruding part. The electric control drives a solenoid visible in the body of the injector and the position of which authorizes or bans the passage of fuel. Then the fuel is injected directly or indirectly in the combustion chamber by a nozzle tip of the injector.

When the injector is worn and must be changed, it is necessary to extract it from its housing by the outside surface of the cylinder head. This operation can be cumbersome when the injector is stuck in its housing because of oxidation phenomena and carbon existence in particular. There are very well known processes and tools that enable the removal of the injector from its housing. Conventionally, the processes consist in removing the electric control of the injector and managing to screw an extractor there. For example such an extractor is the form of a slide hammer comprising a donned sledge hammer on a shank with a nozzle. The injector is then extracted after the impact of the sledge hammer against the shank nozzle according to an extraction direction parallel to the longitudinal axis of the injector.

There are also processes and tools that enable the removal of the injector from its high-pressure connection. An extractor is fixed to this connection and includes a shank connected to a handle and a slide hammer donned around the said shank so as to be fixed vertically when the rod is fixed to the high-pressure connection of the injector. The injector is then extracted by the vertical impact of the sledge hammer against the nozzle of the shank. The seizing due to the existence of carbon may make this operation difficult. There is therefore a need for a process and a set of tools allowing to improve the extraction of the injector from its housing via its high-pressure connection.

In addition, depending on the injector models, the high-pressure connections can be different, and it would be interesting to find a process and a unique (or universal) set of tools to extract these different injectors. Finally, the correct positioning of the slide hammer is not always made possible because of the congestion in the engine environment and it would be interesting to offer a process and a set of tools that can be adapted to different engine environments.

### SUMMARY

The invention is intended to meet at least one of the problems of the previous method by offering a new process, tool and kit for extracting an injector that are easy to use, operated in different engine environments and adapted to any type of injector.

To this effect, and according to a first aspect, the purpose of this invention is about an extractor for extracting an engine injector from a motor vehicle, this injector being stuck in a housing with a high-pressure connection, the extractor comprising: a plunger comprising a stem at the end of which a handle is fixed and on its other end having assembly means on the high-pressure connection of the injector; and
a slide hammer comprising a donned sledge hammer on a shank with a nozzle on one end and being fixed by its other end to the plunger using a connecting component;
the extractor being remarkable in that the connecting component is a joint component connected by a pivoting link sliding on the stem of the plunger and so that the stem has the size that allows the joint component to slide on its length when this extractor is fixed on the injector.

According to particular operating procedures, the extractor can feature one or other of the following characteristics, taken separately or according to all possible combinations:
the joint component is linked to one of the ends of the slide hammer shank by a pivoting link, the joint component preferably has a pivot axis around the stem of the plunger that is perpendicular to the pivot axis of its pivoting link with the slide hammer.
the assembly means of the plunger to the high-pressure connection are in the form of an outer thread or a threaded bore.

The invention also involves a kit for extracting an engine injector of a motor vehicle, the said injector being stuck in a housing and with a high-pressure connection, the kit comprising an extractor as defined above and one or several elements selected from among;
a connecting element;
an adapter;
at least one spacer.

According to particular operating procedures, the kit can feature one or other of the following characteristics, taken separately or according to all possible combinations:
the assembly means of the plunger to the high-pressure connection come in the form of a threaded bore, the kit also includes a removable connecting element for mounting the extractor to the high-pressure connection of the injector, the said connecting element is in the form of a threaded shank on its two ends, preferably a threaded shank throughout its length.
the assembly means of the plunger to the high-pressure connection is in the form of a threaded bore or an outer thread, the kit also includes a removable adapter for mounting the extractor to the high-pressure connection of the the injector, the adapter has a socket for receiving the high-pressure connection and a threaded bore provided at its configured bottom to operate with an outer thread supported by the said high-pressure connection, and additional assembly means to those presented by this plunger for mounting it to the high-pressure connection or additional to the connecting element.
at least one removable spacer in the form of a sleeve designed to be positioned on the stem of the plunger in order to limit the joint component traveling along the said stem.

According to a second aspect, the purpose of invention is an extraction process for an engine injector of a motor vehicle, this injector being stuck in a housing and having a high-pressure connection, the process comprising the following steps:

a) mounting an extractor to the high-pressure connection of the injector; and

b) extracting the injector using the extractor according to a direction parallel to its longitudinal axis,

since the process is remarkable in that it includes the use of an extractor or a kit as defined above, and in that step b) also includes the rotating drive of the injector around its longitudinal axis by repeated impacts of the slide hammer on the stem of the plunger according to a direction being different from the injector extraction direction so as to retrieve it.

Step a) dealing with the mounting of the extractor preferably includes the setting up of at least a spacer on the stem of the plunger between the handle and the joint component and/or between the joint component and the said high-pressure connection.

Step a) dealing with the mounting of the extractor preferably includes the fixing up of the extractor to the high-pressure connection using an adapter and/or a connecting element.

Preferably, the joint component is positioned to a stop against the handle of the plunger or against a spacer during the impact operations on the stem by the slide hammer in order to make the injector start rotating so that the distance between the handle and the joint component is shorter than the distance between the joint component and the high-pressure connection of this injector.

As it will be understood after reading the definition which has just been given, the invention provides a tool and an extraction process for an injector allowing to retrieve the injector from its housing by rotating around its longitudinal axis before or simultaneously to the exertions provided for its vertical extraction or according to an axis parallel to its longitudinal direction. Unlike the prior method, the slide hammer is not fixed in a vertical position and can be moved on one and the other side of the stem of the plunger or positioned vertically. The extraction step of the injector is best performed with the combination of two movements, a translation towards the top and a rotation according to the longitudinal axis of the injector. The positioning of the slide hammer according to an angle less than 90 degrees horizontally allows you to pull the stem on one side of the injector. During the retrieval operation, the slide hammer will be positioned on one side of the stem of the plunger according to a specific horizontal angle so as to trigger the injector rotation according to its longitudinal axis in a specific rotation direction, then the hammer will be used on the other side of the stem of the plunger so as to trigger the injector rotation in the other direction. The tilt angle of the slide hammer in relation to the horizontal may be suited depending on the vehicle and engine environment.

The impact operations are preferably preceded by a translation movement of the joint component along the stem of the plunger to a position chosen by the operator. This position can be selected for the freedom of movement it provides, for example positioned to a stop against the handle of the plunger or against a spacer. Therefore, the invention allows to endow the exerted forces with torque for the injector rotation around its longitudinal axis and thus facilitates this operation.

The use of spacers is beneficial in that the invention allows then to keep the joint component away from the handle and/or the high-pressure connection in order to facilitate the handling of the slide hammer in a congested engine environment.

The extractor can be directly or indirectly fixed to the high-pressure connection of the injector. The extractor is indirectly fixed to the high-pressure connection, the latter can be fixed in different ways depending on the profile of the said high-pressure connection through different connecting elements and/or adapters. The use of these intermediary components is beneficial in that they contribute to the protection of the injector. Indeed, the high-pressure connection of an injector is a component with a certain degree of fragility, and the invention makes it possible to strengthen the mounting of the plunger to the said high-pressure connection so that it does not yield during the rotation and extraction operations.

The extractor and the kit of which it is part of are remarkable for their adaptability to different injector models on the market. The kit is a universal extraction kit that can be used on the vast majority of injectors known to date.

### BRIEF DESCRIPTION OF THE DRAWINGS

The invention will be well understood and other aspects and advantages will appear clearly after reading the description that follows, given as an example with reference to the drawing planks attached on which:

FIG. 1a is a view showing the extraction step of an injector using an according to the invention.
FIG. 1b is a sectional view of FIG. 1a as shown.
FIG. 2 is a similar view to that of FIG. 1b with the difference that the extractor has a spacer according to the invention.
FIG. 3 is a cross sectional view of the step dealing with the mounting of the extractor according to the invention with one injector.
FIGS. 4a and 4b are two cross-sectional views of the step dealing with the mounting of an extractor according to the invention concerning the same injector according to different operating procedures.

### DESCRIPTION

In the following description, the term “comprise” is synonymous with “include” and is not restrictive in that it allows the presence of other elements in the extractor, the kit and the process it is related to. It is understood that the term “comprise” includes the terms “consist in”. In the various figures, the same references are used to designate elements that are identical or similar.

In this brief, the process according to the invention will be described in parallel to the tools in relation to the invention for the implementation of the said process.

Reference is made in the first place in FIGS. 1a and 1b which show the same step for extracting an injector using an extractor according to the invention through two different view angles. In FIG. 1a you can see several injectors 1 including one which is being extracted. In the FIG. 1b, you can see that the injector (1) is seated in the housing (3) of an engine cylinder head (5). The housing (3) of the injector passes through and leads directly to the combustion chamber (7) of the engine. This injector (1) has a body (9) a part of which protrudes from the cylinder head (5) surface. This protruding part extends in the direction of the rest of the body (9) and includes an electric command (11) on its end controlling the fuel injection in the combustion chamber (7). The fuel is supplied under pressure in the body (9) of the injector (1) via a high-pressure connection (13) which extends from the protruding part with a specific angle.

According to the invention, the extractor is remarkable in that it also includes several parts which revolve in relation to each other, namely a plunger (17), a slide hammer (23) and a joint connection (31). The plunger (17) is in the form of a stem (19), whose one end is equipped with a handle (21) and its other end has mounting elements to the high-pressure connection (13) of the injector (1). The extractor (15) shown is fixed to the injector (1) by one of the ends of its plunger (17). The extractor (15) also includes a slide hammer in the form of a shank (25) which has a donned sledge hammer (27) around it. The shank (25) has a nozzle (29) on one end and is fixed by its other end to the plunger (17) through a joint component (31). Indeed, according to the invention the extractor (15) is remarkable in that the slide hammer (23) is connected to the plunger (17) by using a joint component (31) which can slide along the shank (25) of the plunger (17). The joint component (31) is in the form of a hinge with two parts revolving around a common axis. One of the parts include a threaded ring around the stem (19) of the plunger (17) so as to be articulated by a pivoting link sliding with the latter. The other part is fixed to the slide hammer (23) so that the latter is articulated by a pivoting link with the joint component (31) via the axis of this one. The joint component (31) favorably has two types of links, and preferably the joint component is also configured so that the pivot axis with the slide hammer (23) is perpendicular to the translation with the stem (19) of the plunger (17).

The process in relation to the invention includes the following steps:
a) mounting an extractor (15) to the high-pressure connection (13) of the injector (1); and
b) extracting the injector (1) by using the extractor (15).

The stem (19) of the plunger (15) is designed so that, during the mounting of the extractor (15) to the high-pressure connection (13) of the injector (1) in step a), the joint component (31) can slide along the said stem (19). Therefore the length of the stem is at least twice that of the joint component, preferably 3 times at least. Moreover, the link being a sliding pivoting-like link, the joint component (31) can be positioned on one or the other side of the stem (19) of the plunger (17) for performing step b).

Indeed, the process is remarkable in that step b) dealing with the extraction of the injector (1) Includes the retrieval of the injector (1) by putting into position of the shank of the slide hammer (23) according to an angle less than 90 degrees horizontally, and the impact of the sledge hammer (27) on the nozzle (29) of the shank (25) so as to trigger the rotation of the plunger (17) and the injector (1) around the longitudinal axis of the injector 1. The angle that the slide hammer creates horizontally may for example be less than 60, 45, 30 or 20 degrees or be positioned horizontally.

This operation can be repeated several times on the same side of the stem (19) of the plunger (17) until the slide hammer (23) positioning is hampered by the engine environment and then repeated on the other side of the stem (19) of the plunger (17) with for example intermittent vertical impacts of the sledge hammer (27) on the shank (25) nozzle (29) of the slide hammer (23), and so on until the injector (1) is extracted from its housing (3). Such joint movements allow you to facilitate the extraction of the injector (1) from its housing (3).

During the extraction process of the injector (1), the engine environment can interfere with the manipulation of the slide hammer so that it is preferable that the joint component (31) does get closer to the handle (21) of the plunger (17) by more than a distance “d”, as shown in FIG. 1b. In such a case and in order to protect the components of the engine environment during the manipulation of the slide hammer (23), one or more spacers (33) can be installed along the stem (19) of the plunger (17) during step a) between the handle of the plunger and the joint component, as shown in FIG. 2. This or these spacers (33) are in the form of a sleeve comprising a central duct that crosses it on both sides whose diameter is suitable so that the said sleeve can slide along the stem (19) of the plunger (17).

During the impacts of the slide hammer (23), the joint component (21) is positioned to a stop against the handle (21) of the plunger (17) or against a spacer (33) when the latter is visible, so that the distance between the joint component (31) and the handle (21) of the plunger (17) is less than the distance between the joint component (31) and the high-pressure connection (13).

Conventionally the high-pressure connection (13) includes an open end with an outer thread or a threaded bore. In that case the assembly means of the plunger to the high-pressure connection are in the form of an outer thread or a threaded bore. The mounting of the extractor (15) to high-pressure connection (13) of the injector (1) may be direct or indirect, it should be indirect preferably.

FIG. 3 illustrates the case of the indirect mounting of the plunger (17) to a high-pressure connection (13) with a threaded bore on its open end. In this sectional view you can see that the assembly means of the plunger (17) are in the form of a threaded bore and are fixed to the high-pressure connection (13) through a connecting element (35). This connecting element is in the form of a threaded shank on its two ends, whose one end is screwed into the threaded bore of the high-pressure connection (13), and the other is screwed to the assembly means of the plunger (17). Step a) dealing with the mounting of the extractor (15) to the high-pressure connection (13) is completed when the plunger (17) comes to a stop against the high-pressure connection (13). This stopping process also participates in the firmness of the mounting of the extractor to the high-pressure connection.

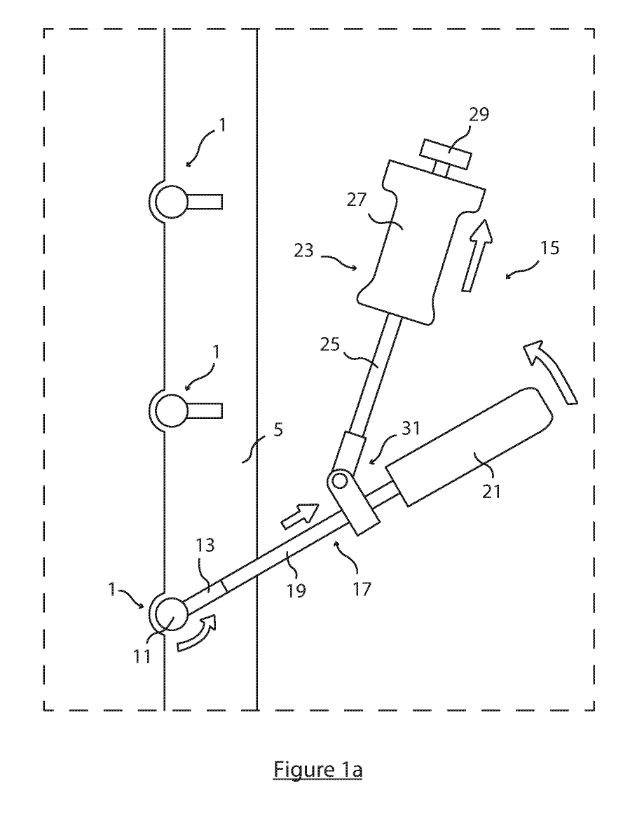

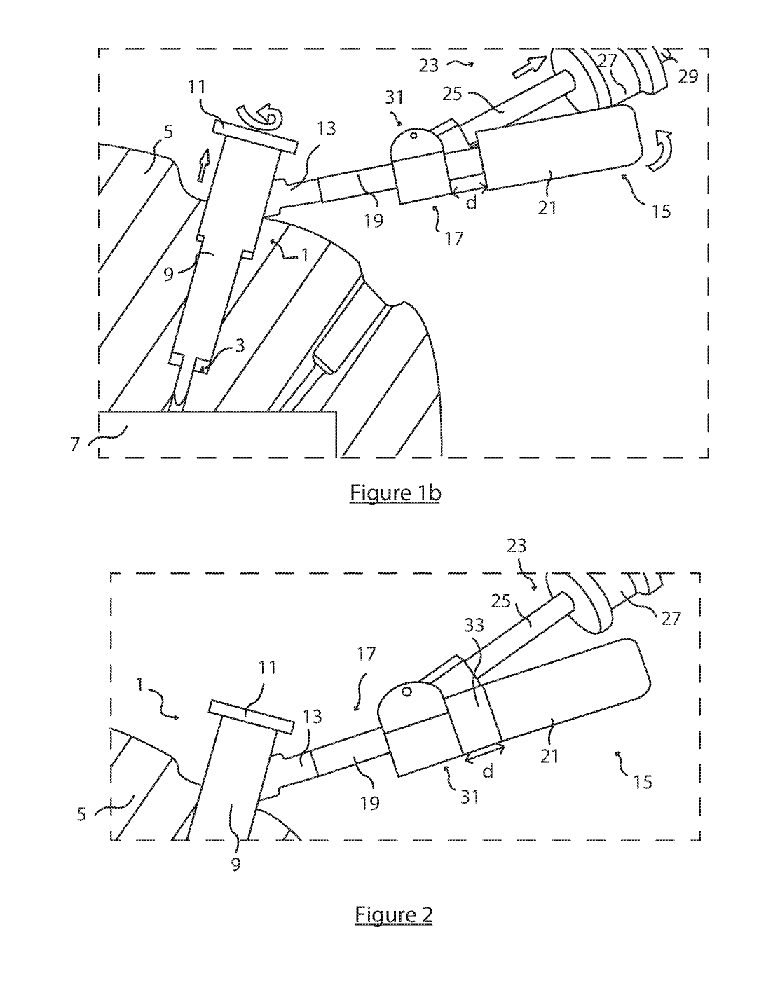

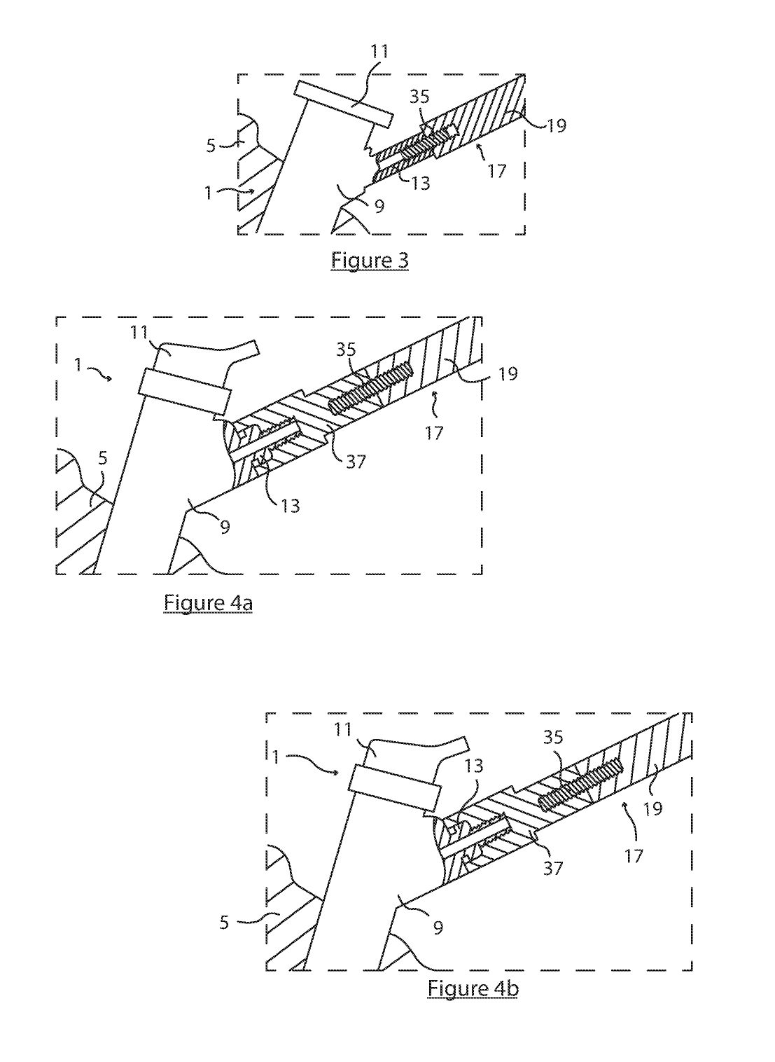

FIGS. 4a and 4b illustrate two operating procedures in the case of the indirect mounting of of the plunger (17) to a high-pressure connection (13) with an outer thread on its open end. Conventionally the said threaded end also has a diameter smaller than the diameter related to the rest of the high-pressure connection (13). According to a first operating procedure of the invention shown in FIG. 4a, the assembly means of the plunger (17) are in the form of a threaded bore and are fixed to the high-pressure connection thanks to a connecting element (30) as described above and an adapter (37). The said adapter (37) has assembly means for the plunger (17) additional to the outer thread of the connecting element and a socket for receiving the high-pressure connection (13). The socket has a threaded bore provided at its bottom and designed to operate with the thread supported by the high-pressure connection (13) open end. Step a) dealing with the mounting of the extractor (15) to the high-pressure connection (13) is completed when the adapter (37) comes to a stop against the stem (19) of the plunger (17) and the high-pressure connection (13) or the body (9) of the injector (1). The socket is designed so as to be able to operate with a part of the non-threaded outer walls of the high-pressure connection (13) and thus participates in the firmness of the mounting of the extractor (15) to the high-pressure connection (13).

Alternately and according to a second operating procedure shown in FIG. 4b, the assembly means of the plunger (17) are in the form of an outer thread and are fixed to the high-pressure connection (13) through an adapter (37) as previously described in which assembly means here are additional to those comprised by the plunger 17. Step a) dealing with the mounting of the extractor (15) to the high-pressure connection (13) is completed when the adapter (37) comes to a stop against the stem (19) of the plunger (17) and the high-pressure connection (13) or the body (9) of the injector (1).

It is noted that this patent claims priority from Belgian Patent Application Serial Number BE 2017/5230 which was filed on Mar. 31, 2017, and French Utility Model 1770327, filed on Mar. 31, 2017. Both Belgian Patent Application Serial Number BE 2017/5230 and French Utility Model 1770327 are hereby incorporated by reference in their entireties.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. An extractor to extract an engine from a motor engine, an injector being stuck in a housing and having a high-pressure connection, the extractor comprising:
a plunger with a stem at an end of which a handle is fixed, and having an assembly means to couple to the high-pressure connection of the injector on another end; and
a slide hammer including a sledge hammer threaded onto a shank, the shank having a nozzle on one end and is fixed by its other end to the plunger through a connecting component;
wherein the connecting component of the extractor is a joint component connected by a pivoting link sliding on the stem of the plunger, and the stem having a size to allow the joint component to slide on its length when the extractor is fixed to the injector.

2. The extractor as defined in claim 1, wherein the joint component is connected by a pivoting link to an end of a slide hammer of the shank; the joint component having a pivot axis around the stem of the plunger which is perpendicular to the pivot axis of its pivoting link with the slide hammer.

3. The extractor as defined in claim 1, wherein the assembly means of the plunger to the high-pressure connection are in the form of an outer thread or a threaded bore.

4. An extraction kit for an engine injector of a motor vehicle, the injector being stuck in a housing and having a high-pressure connection, the kit comprising:
an extractor including a plunger with a stem at an end of which a handle is fixed, and having an assembly means to couple to the high-pressure connection of the injector on another end, and one or several elements selected among a connecting element;
an adapter; and
at least one spacer.

5. The extraction kit as defined in claim 4, wherein the assembly means of the plunger to the high-pressure connection being in the form of a threaded bore, and wherein the assembly means includes a removable connecting element for mounting the extractor to the high-pressure connection of the injector, the connecting element is in the form of a threaded shank on its two ends.

6. The extraction kit as defined in claim 4, wherein the assembly means of the plunger to the high-pressure connection is in the form of a threaded bore or an outer thread, wherein the kit includes a removable adapter for mounting of the extractor to the high-pressure connection of the injector, the adapter having a socket for receiving the high-pressure connection and a threaded bore provided at a bottom portion to operate with an outer thread supported by the high-pressure connection and additional assembly means for mounting the plunger to the high-pressure connection or complementary to the connecting element.

7. The extraction kit as defined in claim 4, wherein the at least one removable spacer is a sleeve to be positioned on a stem of the to limit movement of the joint component along the said stem.

8. A method for extracting an engine injector of a motor vehicle stuck in a housing and having a high-pressure connection, the method comprising:
a) mounting an extractor to the high-pressure connection of the injector, the extractor including a plunger with a stem at an end of which a handle is fixed, and having an assembly means to couple to the high-pressure connection of the injector on another end;
b) extracting the injector via the extractor in an injector extraction direction parallel to a longitudinal axis of the extractor,
rotating a drive of the injector around a longitudinal axis of the longitudinal axis by impacting a stem of the plunger with a slide hammer in a direction different from the injector extraction direction.

9. The method as defined in claim 8, further including mounting the extractor by setting up of at one least spacer on the stem of the plunger between a handle and a joint component or between the joint component and the high-pressure connection.

10. The method as defined in claim 8, further including positioning the joint component to a stop against the handle of the plunger or against a spacer during the impact operations of percussion on the stem for triggering rotation of the injector so that a distance between the handle and a joint component is less than a distance between the joint component and the high-pressure connection of the said injector.

11. The extraction kit as defined in claim 5, wherein the threaded shank of the connecting element includes a threaded shank throughout its length.
